(19) United States
(12) Patent Application Publication
(10) Pub. No.: US 2018/0333861 A1
(43) Pub. Date: Nov. 22, 2018

(54) Robotic Training System

(71) Applicant: KUKA Roboter GmbH, Augsburg (DE)

(72) Inventors: Andreas Keibel, Augsburg (DE); Henry Arenbeck, Duisburg (DE); Melanie Kolditz, Aachen (DE); Kirsten Albracht, Koln (DE); Dirk Abel, Aachen (DE); Gert-Peter Brueggemann, Koln (DE)

(21) Appl. No.: 15/546,089

(22) PCT Filed: Dec. 10, 2015
(86) PCT No.: PCT/EP2015/002492

§ 371 Date: Jul. 25, 2017

(30) Foreign Application Priority Data
Jan. 26, 2015 (DE) 10 2015 000 919.2

(51) Int. Cl. B25J 13/08; A61H 1/02

(52) U.S. Cl. CPC B25J 13/08; A61H 1/024; B25J 13/089; B25J 13/085; A61H 2201/5007; A61H 2201/5064; A61H 2201/5084; A61H 2230/045; A61H 2230/605; A61H 2201/1659

(57) ABSTRACT

A method for controlling the robot of a training system according to any of the previous claims, wherein a biomechanical and/or cardiovascular stress of the user, particularly based on a measured impingement of the actuation surface, is determined and the robot is controlled using a predetermined and the measured biomechanical and/or cardiovascular stress of the user. A computer program product with a program code, which is saved on a medium readable by the computer, for implementing a method according to the previous claim.

### CROSS-REFERENCE

This application is a national phase application under 35 U.S.C. § 371 of International Patent Application No. PCT/EP2015/002492, filed Dec. 10, 2015 (pending), which claims the benefit of German Patent Application No. DE 10 2015 000 919.2 filed Jan. 26, 2015, the disclosures of which are incorporated by reference herein in their entirety.

### TECHNICAL FIELD

The present invention relates to a training system with a robot-guided actuation surface, a method for controlling a robot of the training system, as well as a computer program product for implementing the method.

### BACKGROUND

A physiotherapy device is known from WO 2011/076240 A1 featuring a robot which guides an actuation surface. The actuation surface can be guided along a predetermined trajectory in order to passively train a user. A six-dimensional force-momentum measurement allows additionally an isometric, eccentric, or concentric training, by the robot applying a force upon the actuation surface, which is equivalent to a force applied by the user (isometric training), slightly exceeds it such that the actuation surface moves against the resistance of the user (eccentric training), or slightly falls short thereof so that the user moves the actuation surface against the resistance of the robot (concentric training).

An emergency-off or dead-man switch may be provided as a safety system, which immediately stops the robot.

One objective of the present invention is to improve robotic training.

### SUMMARY

This objective is attained in a training system as shown and described herein.

According to one aspect of the present invention a training system features a robot. The robot comprises in one embodiment, one or more arms with respectively at least six joints, particularly actuated by electric motors, particularly rotary joints, particularly featuring rotary axes aligned perpendicularly in pairs towards each other or parallel. In a further development, the robot features at least one arm with at least seven joints, with this redundancy allowing to be used advantageously for avoiding singular poses, in particular.

In one embodiment, the training system features at least one actuation surface, which can be fastened, particularly in a detachable fashion, at the robot, particularly a robot flange, which features degrees of freedom defined in reference to a particularly stationary robot base, defined by all joints of the robot, which can be fixed, particularly fastened and thus be guided by the robot.

The actuation surface is provided and/or embodied as a user interface and/or user contact site to the robot. In one embodiment it may be provided with an at last essentially planar platform, for example to support one or both feet. Similarly, an actuation surface can also be curved, particularly cylindrically, for example including a handle for holding it with one or both hands. In one embodiment the actuation surface is equivalent to a contact surface of a sporting device, with the user thereof being intended to train the user in a training system, for example a shaft of a track-and-field javelin, a handle of a golf club, or the like. In one embodiment the actuation surface includes a coating made from plastic or rubber and/or a surface structure. This way, advantageously the secure grip and/or the contact of the user can be improved. In one embodiment, the actuation surface may be provided and/or embodied for contact with one or two feet, hands, and/or other body parts, for example the back, shoulder, or the like and/or contact them during operation.

In one embodiment, the training system features a force detection means for determining an impingement of the actuation surface. The impingement includes in one embodiment a force applied in one or more, particularly three directions, preferably orthogonal in reference to each other, and/or a torque in one or more, particularly three directions, preferably orthogonal in reference to each other. For a more compact implementation, in the present case an anti-parallel pair for forces and/or torques is called (one) force, for simplification.

In one embodiment, the force detection means includes one force and/or torque sensor, particularly covering several dimensions, preferably six, which in one embodiment can be arranged between the robot flange and the actuation surface, particularly a coupling, for the detachable fastening of the actuation surface at the robot flange.

In addition, or alternatively, the force detection means includes one or more force, particularly torque sensors in one or more, particularly in all joints of the robot. In particular in consideration of a mechanic model of the robot, especially its inertia, here also any one-dimensional or multi-dimensional impingement of the robot-guided actuation surface can be determined.

According to one aspect of the present invention the training system includes an activity detection means for determining a biomechanical and/or cardiovascular stress of the user, particularly based on an impingement of the actuation surface determined by the force measuring means.

Biomechanical stress includes, particularly represents in one embodiment a particular mechanic stress and/or impingement of the support and/or motion apparatus, particularly of joints, muscles, tendons, and/or ligaments of the user, particularly of the joints of the motion system, particularly the skeleton. A mechanic stress upon the support and motion system includes in one embodiment forces, torques, tensions, and/or extensions upon the biological structures of the support and motion system, particularly at the muscles, tendons, ligaments, cartilage, bones, and/or joint areas, particularly the biomechanical parameters of joint moments and/or joint forces. Accordingly, in one embodiment here a biomechanical stress includes for example a stress, particularly of the joint areas of a hip, knee, and/or foot joint, the extensors and/or flexors of the hip, the thigh, and/or the calf muscles, the exterior, interior, and/or cruciate ligaments of knee and/or foot joints, the Achilles tendon, or the like.

A cardiovascular stress includes, particularly represents in one embodiment a stress and/or impingement of the cardiovascular system of the user.

In one embodiment a biomechanical and/or cardiovascular stress includes particularly an acute stress and/or any such stress occurring during the actuation of the training system. Alternatively or additionally a biomechanical and/or cardiovascular stress may include particularly a long-term stress occurring after the actuation of the training system.

A biomechanical stress can particularly include mechanical forces and/or moments and/or a (potential) damage and/or wear of particularly the motion system and/or tissue structures of the user. Additionally or alternatively a biomechanical stress in the sense of the present invention may also include a training effect, particularly an improved capability of the user in reference to an initial status. Even such a training effect, which biologically represents a reaction to a mechanic stress, is generally called a biomechanical stress in the present case.

When the user impinges the actuation surface, this results in a biomechanical stress as a reaction thereof, particularly of his/her motion system and/or a cardiovascular stress, particularly of the cardiovascular system. Accordingly, particularly based on models and a determined impingement of the actuation surface, a biomechanical and/or cardiovascular stress of the user can be determined as well.

Training devices according to prior art, particularly including WO 2011/076240 A1 mentioned at the outset, fail to consider however the biomechanical and/or cardiovascular stress of the user by concentrating on the (absolute) impingement of the actuation surface itself, for example by applying a certain force upon the actuation surface.

This may however disadvantageously stress the user particularly his/her motion system and/or cardiovascular system, particularly excessively and/or sub-optimally under training aspects. For example, when in one functional direction only a constant force is predetermined in one direction of displacement, this may insufficiently or excessively stress the muscles, depending on the lever arms acting here. Additionally, for example the knee can be overloaded when the direction of displacement fails to correlate with the axis of the leg and/or the knee joint.

Therefore, according to one aspect of the present invention the training system includes a control means, which regulates the robot, particularly its drives, based on a predetermined and the measured biomechanical and/or cardiovascular stress of the user, and is designed for this purpose particularly by utilizing hardware and/or software means.

This way, advantageously the risk of a biomechanical and/or cardiovascular faulty stress, particularly excessive stress, can be reduced. For example, any forces and/or moments acting upon a knee joint of the user can be determined based on the measured impingement of the actuation surface and compared to a predetermined, particularly desired and/or permitted stress. Then the control means can regulate the robot such that the forces and momentums acting in the knee joint of the user approach the desired stress or abstain from exceeding the permitted stress.

Additionally or alternatively this way the training impulse can be improved. For example, based on the determined impingement of the actuation surface here a muscular stress, for example in the knee extensor, can be determined and compared to a predetermined optimal training impulse. Then the control means can control the robot such that the forces acting in the knee extender of the user approach the desired training stress, for example by a (counter) force of the robot upon the actuation surface due to increasing an extended lever arm or the like.

As stated above, a biomechanical stress in the sense of the present invention may include mechanic forces and/or moments and/or a training effect. Accordingly, in one embodiment the control means may compare predetermined and measured forces and/or moments in joints, muscles, tendons, and/or ligaments of the user and/or a predetermined and measured, particularly muscular, tissue, and/or motoric training effect and can control the robot based on this predetermined and measured biomechanical stress, and/or be designed to control these aspects via hardware and/or software technological means. In general, this way the control means controls the robot in one embodiment such that a difference between the predetermined and the measured biomechanical and/or cardiovascular stress of the user is reduced and/or the control means is designed to do this using hardware and/or software technology.

In one embodiment the activity detection means determines the stress of the user based on at least one biomechanical and/or cardiovascular model and/or is implemented for this purpose, particularly by using hardware and software means. The biomechanical and/or cardiovascular model connects in one embodiment an impingement of the actuation surface with a biomechanical and/or cardiovascular stress of the user, particularly in the form of a relational connection, particularly a one-dimensional or multi-dimensional embodiment.

In one embodiment, the activity detection means includes several biomechanical and/or cardiovascular models, particularly model modules, which in one embodiment represent different parts of the motion system of the user and/or includes different degrees of complexity. Then, in one embodiment the activity detection means optionally prepares, particularly depending on the application case, particularly a training plan, from these modules respectively a biomechanical and/or cardiovascular model, on the basis of which then the stress of the user is determined. In one embodiment one or more biomechanical and/or cardiovascular models are implemented in an object-oriented fashion, which can facilitate particularly the connection thereof.

In one embodiment one or more biomechanical and/or cardiovascular models can be parameterized, particularly in order to adjust them individually to a user. The parameters of the model are entered in one embodiment by the user or a trainer or determined from a database, in particular by identification of a user identity and recalling parameters from a storage medium allocated to said user identity.

Additionally or alternatively one or more of the parameters may also be determined by the training system itself, particularly identified or estimated. For example, a maximum motion range of one or more joints and/or a maximum force of one or more muscles of the user may be determined by a single or repeated motion of the actuation surface, particularly against a predetermined resistance.

In one embodiment the activity detection means determines the biomechanical and/or cardiovascular stress of the user additionally or alternatively based on a determined condition of the user and/or is equipped for this purpose particularly with hardware and/or software technological means. In particular, in one embodiment the biomechanical and/or cardiovascular model may connect any impingement of the actuation surface and a determined condition of the user with a biomechanical and/or cardiovascular stress of the user, particularly in the form of a relational connection, particularly in a one-dimensional or multi-dimensional implementation.

The condition of the user may include particularly a position, speed, and/or acceleration of one or more references of the user, particularly points of joints or axes of joints, or represent it. In one embodiment the condition of the user is (also) determined via ultrasound. Accordingly, in one embodiment the activity detection means features at least one ultrasound sensor.

For example, based on the detected positions of the markers arranged at the user and/or based on the positions of references identified based on a user image detection, particularly based on a biomechanical and/or cardiovascular model, the positions of joints and/or muscles of the user can be detected, and the stress acting here be determined.

Accordingly, the activity detection means determine in one embodiment the condition of the user based on a detected, particularly multi-dimensional position and/or acceleration of the user, particularly one or more references of the user, and/or is equipped for this purpose with hardware and/or software technology. In particular, for this purpose it may include one or more position sensors and/or acceleration sensors, particularly inertial ones, arranged at the user. The sensors may be active or passive and/or actively detect and transmit data, or such data may be passively detected by appropriate measuring means.

Additionally or alternatively, the activity detection means may include one or more room monitoring sensors, particularly fixed with regards to the robot or the environment, particularly light sensors, scanners, cameras, or the like. This way as well, particularly a multidimensional position and/or acceleration of the user can be determined, especially of one or more references of the user, particularly using image detection.

The condition of the user can additionally or alternatively include particularly nerve and/or muscle activities of the user. Accordingly, the activity detection means determines in one embodiment the condition of the user based on a measured, particularly multi-dimensional nerve and/or muscle activity of the user and/or is equipped for this purpose with hardware and/or software technology, in particular. For this purpose, in particular one or more EMG-sensors may be arranged at the user.

By means of considering the nerve and/or muscle activities, advantageously the precision can be increased and/or redundancy of one biomechanical model can be dissolved.

The condition of the user can additionally or alternatively include particularly cardiovascular activities of the user. Accordingly, the activity detection means determines in one embodiment the condition of the user based on a detected, particularly multi-dimensional cardiovascular activity of the user and/or is equipped for this purpose with hardware and/or software technology. For this purpose, in particular one or more sensors may be arranged at the user for determining one-dimensional or multi-dimensional cardiovascular parameters, particularly blood pressure values, pulse values, blood oxygen values, or the like.

By considering the cardiovascular activities advantageously the precision and/or safety during training activities can be increased.

The condition of the user may additionally or alternatively include sizes of biological structures of the user, particularly muscles, tendons, ligaments, and the like. Accordingly, the activity detection means determines in one embodiment the condition of the user based on a detected, particularly multi-dimensional size of a biological structure of the user and/or is equipped for this purpose, particularly with hardware and/or software technology means. For this purpose it may be provided with one or more, particularly non-invasive sensors for determining a one-dimensional or multi-dimensional size of a biological structure of the user, particularly muscles, tendons, ligaments, and the like. In a further development thereof, the sensor includes an imaging and/or image-processing means for detecting the dimension of the biological structure.

For example, the activity detection means and/or its sensors may detect and/or determine in one embodiment a length of a patella tendon or Achilles tendon using sonography as the dimension of a biological structure, determine therefrom the extension of the patella and/or Achilles tendon as the condition of the user, and determine therefrom a particularly biomechanical stress of the user and/or be equipped for this purpose with hardware and/or software technology.

In one embodiment the control means regulates a force, particularly its direction and/or intensity and/or amount, which the robot applies upon the robot-guided actuation surface, particularly applies and/or exerts minimally, maximally, or presently, based on the predetermined or measured biomechanical and/or cardiovascular stress of the user and/or is equipped for this purpose with particular hardware and/or software technology. As explained above, torque is also called a force in the present case in a generalizing fashion.

The control means can particularly control a strength and/or direction of force by which the robot impinges the actuation surface, particularly moves it, and/or counteracts the motion of the actuation surface, such that a measured biomechanical and/or cardiovascular stress of the user approaches a predetermined biomechanical and/or cardiovascular stress of the user and/or counteracts it.

If for example excessive biomechanical stress of the knee joint is detected, the control means can reduce the force by which the robot impinges the actuation surface and/or change its direction such that the biomechanical stress of the knee joint is reduced. In particular, the control means can adjust a biomechanical stress into a beneficial axis by an appropriate alignment of the force exerted by the robot.

Additionally or alternatively the control means controls in one embodiment a motion of the robot-guided actuation surface by the robot, particularly a direction of motion and/or speed of the robot-guided actuation surface, based on the predetermined and the measured biomechanical and/or cardiovascular stress of the user and/or is equipped for this purpose particularly with hardware and/or software technology.

The control means can particularly control a speed and/or direction of a motion of the actuation surface by the robot such that a measured biomechanical and/or cardiovascular stress of the user approaches a predetermined biomechanical and/or cardiovascular stress of the user and/or counteracts it.

For example, if excessive biomechanical stress of the knee joint is determined, the control means can change the direction of motion of the robot-guided actuation surface such that the biomechanical stress of the knee joint is reduced.

In one embodiment the control means controls the robot in an adaptive fashion, particularly control parameters and/or control structures can be automatically changed during and/or after an actuation of the training system by a particularly identified user, particularly based on biomechanical and/or cardiovascular stress determined during the actuation.

According to one aspect of the present invention the training system features a safety means for a particularly redundant, particularly diverse monitoring of the impingement of the actuation surface, the biomechanical and/or cardiovascular stress of the user measured, and/or a condition of the robot. In a further development the safety means detects for this purpose the impingement of the actuation surface and/or the condition, particularly an especially multi-dimensional position, speed, and/or acceleration of the user and/or the robot, in two channels, and/or is equipped for this purpose with particular hardware and/or software technology.

By monitoring the impingement of the actuation area, particularly excess stress of the user (absolute, independent of user biomechanics) can be detected and/or avoided. By monitoring the condition of the robot particularly a potential collision and/or faulty function can be detected and/or reacted to. By monitoring the determined biomechanical and/or cardiovascular stress of the user advantageously excessive stress can then be detected and appropriately avoided when the impingement of the actuation surface per se is (still) within a permitted range. For example, based on the impingement of the actuation surface and a condition, particularly a position of the user based on the biomechanical model, it can be detected that a knee joint is excessively stressed, for example due to a faulty axial positioning, although the absolute force upon the actuation surface is still within a range permitted per se.

If an impermissible impingement of the actuation surface or an impermissible biomechanical and/or cardiovascular stress of the user or an impermissible condition of the robot is determined, the safety means triggers in one embodiment an error reaction and/or is equipped for this purpose with particular hardware and/or software technology.

In one further embodiment the safety means performs a compensating motion of the robotic actuation surface particularly in a predetermined default position if an impermissible impingement of the actuation surface or a biomechanical and/or cardiovascular stress of the user or an impermissible condition of the robot is determined and/or is equipped with particular hardware and/or software technology for this purpose.

By such a compensating motion, particularly compared to an immediate stopping of the robot in an ergonomically disadvantageous position and/or situation, the risk of excess stress or clamping the user can be reduced. If it is determined for example that the impingement of the actuation surface exceeds a predetermined maximum value, instead of a mere stopping of the robot here the robotic actuation surface can be moved to a default position, in which the user is not excessively stressed and/or can better exit the training system.

According to one aspect of the present invention the training system features two or more, particularly different actuation surfaces which can optionally be coupled to the robot, particularly are and/or will be connected thereto. This way advantageously actuation surfaces can be provided adjusted to the user and/or the training, for example handles with different sizes, different platforms, and the like.

In a further development, the control means identifies the respectively robot-guided actuation surface and/or the surface coupled to the robot (flange) and controls the robot based on the identified robot-guided actuation surface and/or for this purpose it is equipped with particular hardware and/or software technology.

In a further development, the actuation surfaces include particularly identification markings that can be scanned, particularly electromagnetically, and the control means includes means for a particularly electromagnetic detection of the identification markers. The identification markers can particularly include RFID-transponders, particularly represent them.

In a further development the training system, particularly the control means controlling the robot, exchanges in a completely or partially automated fashion the robot-guided actuation surface, particularly for another actuation surface that can be coupled to the robot and/or is equipped for this purpose with particular hardware and/or software technology.

In one embodiment the control means identifies the user, particularly in a touchless fashion via RFID, and controls the robot based on the identifiable user and/or it is equipped for this purpose with particular hardware and/or software technology means.

In particular, this way user-individual training plans and/or parameters of the biomechanical model can be used for controlling the robot. Any control may include particularly also the blocking of motions of the robot. Accordingly, the identification can also be used for the identification as well as the authorization of a training session using the training system.

In one embodiment, the training system features a one-piece or multi-part fixation means for fixing the user to the robot-guided actuation surface and/or to a particularly adjustable user positioning device, particularly a standing and/or sitting surface and/or a backrest. This way, advantageously the training process can be improved.

In one embodiment, the training system features an output means for the particularly optical and/or visual, haptic, and/or acoustic output of feedback based on the determined biomechanical and/or cardiovascular stress. This way, the user can be provided with computerized feedback regarding the biomechanical and/or cardiovascular stress, particularly a training effect, and thus it can be advantageously improved.

Means in the sense of the present invention may be embodied in the form of hardware and/or software technology, particularly include a processing unit, particularly a microprocessor unit (CPU), preferably equipped with a memory and/or bus-system for data and/or signal transmission, particularly in a digital fashion, and/or one or more programs or program modules. The CPU may be embodied to process commands implemented in a program stored in a memory system, detect input commands from a data bus, and/or issue output signals to the data bus. A memory system may feature one or more, particularly different storage media, particularly optic, magnetic, solid-matter, and/or other non-volatile media. The program may be designed such that the methods described here are embodied and/or capable to perform such that the CPU can execute the steps of such a method and thus can particularly control the robot.

Training in the sense of the present invention can particularly include and/or intend an improvement of tissue structures, particularly muscles, tendons, and/or ligaments of the user. Additionally or alternatively it may also include and/or intend a nervous, particularly coordinative improvement of the user. Accordingly, the predetermined biomechanical stress of the user may be or will be predetermined, particularly based on an intended improvement of tissue structures and/or based on an intended nervous, particularly coordinative improvement.

Any excessive stress in the sense of the present invention may particularly include and/or represent exceeding a particularly defined and/or predetermined stress limit.

In one embodiment the robot is additionally controlled based on a predetermined, particularly user-specific and/or user-individual range of motion. Accordingly, the control means is in one embodiment provided to control the robot based on a predetermined, particularly user-specific and/or user-individual range of motion and/or equipped for this purpose with hardware and/or software technology. This way, in a particularly advantageous fashion, therapy specifications and/or limits of the range of motion can be considered and/or complied with. This way particularly the robot and/or the control can guide the actuation surface such that one or more joints and/or body parts of the user have only the predetermined range of motion in the robot-guided movement of the actuation surface.

Additional advantages and features are discernible from the accompanying drawings and the description of the exemplary embodiments.

### BRIEF DESCRIPTION OF THE DRAWINGS

FIG. 1 is a training system according to one embodiment of the present invention.

### DETAILED DESCRIPTION

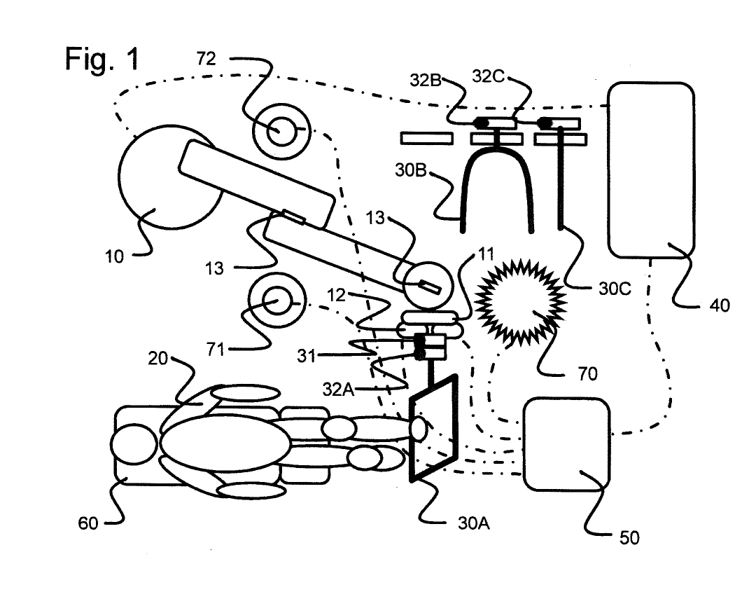

FIG. 1 shows a training system according to one embodiment of the present invention.

The training system features a robot 10. The robot features an arm with six rotary joints actuated by electric motors, with perpendicular or parallel axes of rotation being aligned in pairs in reference to each other.

The training system further features several different actuation surfaces 30A, 30B, and 30C, which are guided optionally in a detachable fashion at a robot flange 11 and thus are guided by the robot. The robot flange 11 shows the degrees of freedom defined by the six joints of the robot in reference to a robot base, which is fixed towards the environment.

In the exemplary embodiment the presently coupled and/or robot-guided actuation surface 30A comprises a platform for supporting one or both feet of a user, so that the training system can particularly act as a so-called function support, as indicated in FIG. 1. The actuation surfaces 30B, 30C are however embodied as a handle for holding with one (30C) or both hands (30B).

The training system features a force detection means for determining a force and momentum impingement of the actuation surface in three directions, respectively orthogonal to each other, in the form of a six-dimensional force/momentum sensor 12, which is arranged between the robot flange 11 and the actuation surface 30A.

The training system features an activity detection means for determining a biomechanical stress of a user 20 based on the measured impingement of the actuation surface as well as control means for controlling the drives of the robot 10 based on a predetermined and the measured biomechanical stress of the user, which are both implemented in a control 40.

In the exemplary embodiment, in which the robot 10 acts as a function support, for example forces and momentum acting in the knee joint of the user 20 are measured based on the determined impingement of the actuation surface 30A using the biomechanical model and compared to the predetermined stress. Then the control 40 controls the robot 10 such that the forces and momentum acting in the knee joint of the user 20 approach the desired stress or prevent that the permitted stress is exceeded.

Additionally the control determines, based on the measured impingement of the actuation surfaced 30A using a biomechanical model, a muscular stress in the knee extender, compares it with a predetermined optimal training stimulus, and controls the robot 10 such that the forces acting in the knee extender of the user 20 approach the desired training stress.

This way, advantageously any excess stress of the knee joint can be avoided and simultaneously the knee extender can be optimally stressed.

The control 40 features several biomechanical model modules, which implement various parts of the motion system of the user and have different degrees of complexity. The control 40 prepares optionally, particularly for each training plan, from these modules respectively the biomechanical model, based on which it then determines the stress of the user 20 and controls the robot 10.

The biomechanical models can be parameterized in order to adapt them to the different users. The parameters of the model are entered by the user or a trainer or determined from the database, particularly by recognizing a user identity and recalling parameters connected to said user identity from a memory unit of the control 40. Additionally or alternatively, one or more of the parameters can also be determined by the training system itself, particularly identified or estimated.

The control 40 considers, when determining the stress of the user 20, additionally a position of references of the user, which are determined in the exemplary embodiment by space monitoring sensors fixed in reference to the environment, for example a camera 70 and appropriate image detection. In a variant, not shown, the position of references of the user can additionally or alternatively be determined by position sensors arranged at the user. In another variant, not shown either, the control 40 can additionally or alternatively also consider nerve and/or muscle activities of the user 20 when determining his/her stress level, which are determined from EMG-sensors arranged at the user.

The references may have a known position in reference to joints of the motion system of the user, for example the knee joint. Then the control 40 can determine the position of the knee joint, based on the registered position of the references and in consideration of the impingement of the actuation surface 30A, and determine the stress in the knee joint.

In the exemplary embodiment the control 40 controls a force, which the robot 10 exerts upon the robot-guided actuation surface 30A as well as a motion of the robot-guided actuation surface by the robot based on the predetermined and the measured biomechanical stress of the user.

If for example based on the determined impingement of the actuation surface 30A excess biomechanical stress of the knee joint of the user 20 is determined, the control 40 can reduce the force by which the robot 10 impinges the actuation surface 30A, particularly a motion opposite that of the user (concentric training) and/or change its direction and/or the motion trajectory of the actuation surface 30A such that the biomechanical stress of the knee joint is reduced, for example (better) correlates a motion of the actuation surface 30A with an axis of motion of the knee joint.

The training system features a safety means with a safety control 50 for monitoring the impingement of the actuation surface 30A, the measured biomechanical stress of the user, and the condition of the robot 10.

The safety control 50 detects via two means the impingement of the actuation surface 30A via the force/momentum sensor 12 and the status, particularly a position, speed, and/or acceleration of the robot 10 via light sensors 71, 72. Additionally, it compares the measured biomechanical stress of the user 20 with a predetermined, permissible biomechanical stress, for example maximally permitted forces in the knee.

If the safety control 50 detects an impermissible impingement of the actuation surface 30A or an impermissible status of the robot 10, for example a force exerted upon the actuation surface 30A exceeding a predetermined limit or the robot 10 leaves the predetermined area set by the light sensors 71, 72, or if the safety control 50 detects an impermissible biomechanical stress of the user 20, it performs a compensating motion of the robotic actuation surface 30A into a predetermined default position.

In addition or as an alternative to the light sensors 71, 72 and/or the camera 70 the safety control 50 can also detect the position of the robot 10 by position and/or joint angle sensors 13 at the joints of the robot.

As already mentioned above, the training system features in the exemplary embodiment three different actuation surfaces 30A-30C, which can optionally be coupled to the robot 10.

The control 40 identifies the respectively robot-guided actuation surface (in the exemplary embodiment 30A) and/or coupled to the robot flange 11 and controls the robot 10 based on the identified robot-guided actuation surface. For this purpose the different actuation surfaces 30A-30C respectively include a RFID-transponder 32A, 32B and/or 32C, the robot 10 includes means 31 for the electromagnetic detection of the respectively coupled RFID-transponder.

The training system features a user positioning device 60 with an adjustable seating area and a backrest.

Although in the previous description exemplary embodiments were explained, it shall be pointed out that a plurality of variants is possible. Additionally, it shall be pointed out that the exemplary embodiments only represent examples which shall not limit the scope of protection, the applications, and the design in any way. Rather, a specialist shall be provided in the previous description with a guideline for implementing at least one exemplary embodiment, wherein various changes, particularly with regards to the function and arrangement of the components described, may be performed without leaving the scope of protection, as discernible from the claims and combinations of features equivalent thereto.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

List of reference characters

| | |
|---|---|
| 10 | robot |
| 11 | Robot flange |
| 12 | force/momentum sensor |
| 13 | joint angle sensor |
| 20 | User |
| 30A, 30B, 30C | actuation surface |
| 31 | means for detecting a RFID- |
| | transponder |
| 32A; 32B; 32C | RFID transponder |
| 40 | (robot)control (activity detection and |
| | control means) |
| 50 | safety control |
| 60 | user positioning device |
| 70 | cameras (room monitoring system) |
| 71, 72 | Light Sensors |

What is claimed is:

1. A training system with
a robot (10);
a robot-guided actuation surface (30A);
an activity detection means (40) for detecting a biomechanical and/or cardiovascular stress of a user (20), particularly based on an impingement of the actuation surface determined by a force detection means (12) of the training system; and
a control means (40) for controlling the robot based on a predetermined and a measured biomechanical and/or cardiovascular stress of the user.

2. A training system according to claim 1, wherein an activity detection means is implemented to determine the stress of the user based on at least one biomechanical and/or cardiovascular model, particularly a modular one and/or one that can be parameterized, and/or a measured status of the user.

3. A training system according to the previous claim, wherein the activity detection means being embodied to determine the status of the user is based on a detected position, acceleration, nerve and/or muscle and/or cardiovascular activity and/or dimensions of a biological structure of the user.

4. A training system according to the previous claim, wherein the activity detection means features at least one particularly inertial position sensor, arranged at the user, acceleration sensor, EMG-sensor and/or at least one sensor for determining a cardiovascular parameter and/or at least one particularly non-invasive sensor for determining a dimension of a biological structure of the user and/or at least one room monitoring sensor (70).

5. A training system according to any of the previous claims, wherein the control means is implemented to control a force, particularly the direction of force and/or the strength of the robot upon the robot-guided actuation surface and/or a motion of the robot-guided actuation surface by the robot, particularly a direction and/or speed of motion, based on the predetermined and the measured biomechanical and/or cardiovascular stress of the user.

6. A training system according to any of the previous claims, featuring a safety means (50) for the particularly redundant monitoring of the impingement of the actuation surface, the measured biomechanical and/or cardiovascular stress of the user, and/or the status of the robot.

7. A training system according to the previous claim, wherein the safety means is implemented to perform compensating motions if an impermissible impingement of the actuation surface or biomechanical and/or cardiovascular stress of the user or an impermissible status of the robot is determined.

8. A training system according to any of the previous claims, wherein the control means is implemented to identify the user (20), particularly in a touchless fashion, and to control the robot based on the user identified.

9. A training system according to any of the previous claims, featuring at least two actuation surfaces (30A, 30B, 30C), which can optionally be coupled to the robot, with the control means being implemented to at least partially automatically change the robot-guided actuation surfaces and/or identify them and to control the robot based on the identified robot-guided actuation surface.

10. A training system according to any of the previous claims, featuring a fixing means for fixing the user to a robotic actuation surface and/or a user positioning device (60).

11. A training system according to any of the previous claims, featuring output means for issuing feedback based on the determined biomechanical and/or cardiovascular stress.

12. A method for controlling the robot of a training system according to any of the previous claims, wherein a biomechanical and/or cardiovascular stress of the user, particularly based on a measured impingement of the actuation surface, is determined and the robot is controlled using a predetermined and the measured biomechanical and/or cardiovascular stress of the user.

13. A computer program product with a program code, which is saved on a medium readable by the computer, for implementing a method according to the previous claim.
